(19) United States
(12) Patent Application Publication
(10) Pub. No.: US 2013/0279318 A1
(43) Pub. Date: Oct. 24, 2013

(54) DATA STORAGE AND RETRIEVAL

(71) Applicants: Libor Kotacka, Velk ites (CZ); Leos Polivka, Kojetice (CZ); Vladimir Zhukov, Praha (CZ)

(72) Inventors: Libor Kotacka, Velk ites (CZ); Leos Polivka, Kojetice (CZ); Vladimir Zhukov, Praha (CZ)

(73) Assignee: ZET Nanolaboratory, Ltd., Victoria (SC)

(21) Appl. No.: 13/823,984

(22) PCT Filed: Sep. 22, 2011
(86) PCT No.: PCT/EP11/66547

§ 371 Date: Jun. 6, 2013

(30) Foreign Application Priority Data
Sep. 22, 2010 (GB) 1015892.1

(51) Int. Cl. G11B 7/1353

(52) U.S. Cl. CPC G11B 7/1353
USPC 369/112.03; 369/112.01

(57) ABSTRACT

The invention provides for a recording method comprising the steps of modulating a first light beam; directing a second light beam to interfere with the first light beam to produce an interference pattern in a region of a recording medium; forming an optical device in the medium responsive to the interference pattern, wherein optical characteristics of the optical device are varied responsive to variations in the interference pattern. A method of playback, a recording and/or reading head and data carriers are also claimed. An example relates to a full diffraction analogy of gramophone recording. The interference of two beams, one of which is functionally linked to an audio signal, results in a change of the diffractive structure that instantly reflects the change of the input signal. On playback the diffracted light beam oscillates in the same way as the gramophone needle would vibrate. Another aspect of the disclosure relates to multilevel digital recording using holographic and/or diffractive structures.

The present invention relates to a method of data/information storage, retrieval and to a related storage medium.

Optical or holographic data storage has been extensively studied, industrially and commercially exploited for the last three decades. There are many known techniques for data storage closely linked to the development of computers such as magnetic memory devices. Optical based data storage systems offer considerable capacity, especially when the information is holographically coded. For further information see e.g. “Holographic Data Storage Coufal H.J. Psaltis D., Sincerbox G. T. (Eds.), Springer Berlin, 2000”, and “Curtis K., Holographic Data Storage, Wiley, 2010” and references therein.

The very first commercially successful optical based data storage technology comprises the Compact Disc (CD), followed by well known media such as DVD, BD, SACD, etc. wherein binary data is written in a form of laterally collocated single tracks of lands and pits. Such tracks then relate to the binary code, thus determining bit “0, 1” information. The information is laser written and subsequently retrieved by reflecting the light beam from the pertinent lands and pits. Further, a specific data storage laser written technology is commercialized by LaserCard, California.

The principal goal of any data storage system is to encompass as much information/data on the smallest possible area or into the smallest volume. Thus the current state of the art approaches a capacity of hundreds GB per inch squared. When considering 3D recording the theoretical limit is to comprise 1 bit per cube size in the order of the wavelength of the writing beam. In general, research is focused on increasing the capacity of the disc/media up to 1 TB, or towards increasing the transfer (upload/download) speed. Holographic data storage breaks through the physical limitations of standard storage technologies by going beyond two-dimensional layered approaches in order to write in three dimensions, rather in two dimensions in several levels. All known techniques such as those above, however, handle bit-wise signals, such that binary scales are used for the data storage. So far, no prior art has proposed high density analogue signals data storage or, say, multi-level binary systems such as base-16 systems.

A holographic system for a discrete kind of data storage and play-back, thus data reconstruction or reading, where the data is recorded in a form of a diffractive grating, is described in (Mikaelyan, Soy. J. Quantum Elecron. 17 (5), May 1987, pp. 680). This paper teaches a technique similar to a standard CD writer, where the binary spots are positioned on a spiral. Each data-dot comprises grating grooves and so when reading the data, the light beam is diffracted to a pertinent, but constant angle.

However, such known systems, apparatus and methods exhibit limitations and disadvantages with regard in particular to the quality and capacity of data/information storage and retrieval and the controlled limitation thereof in particular.

According to a first aspect of the present invention there is provided recording method comprising the steps of modulating a first light beam for recording purposes; directing a second light beam to interfere with the said first light beam to produce an interference pattern in the region of a recording medium; forming an optical device in the said medium responsive to the said interference pattern and wherein optical characteristics of the said optical device are varied responsive to variations in the said interference pattern.

The efficiency and accuracy of data/information recording/retrieval is advantageously improved by way of the invention was also exhibiting markedly improved copy-protect characteristics.

Preferably, the first and second light beams can comprise coherent light such as for example laser light.

The said first beam is preferably modulated by a light modulator, and, in one aspect, a method can include splitting the said first light beam prior to the said modulation step. Of course, as an alternative, the method can include splitting the beam after modulation.

The method is not limited as to the number of beams that can be modulated and so, in one arrangement, at least two parts of the split beam can be modulated.

Presently, a variable optical characteristic of the said structure can comprise at least one of period, pitch, profile shape and/or high or modulation and orientation of the grating structure.

The method can then include the step of causing the said optical characteristic to vary in at least one of a substantially continuous, stepwise and/or discrete manner in the direction of relative movement between the interference and/or holographic pattern and the recording medium.

In particular, the method can include forming the optical characteristic as a track in the recording medium.

In one embodiment, the invention can involve forming discrete optical devices aligned in the direction of relative movement between the interference pattern and the recording medium or otherwise spatial relation.

In one configuration, there can be provided a plurality of differing optical devices within a common discrete region or arranged in a continuous region.

As will be appreciated, the method can comprise an analogue recording method and/or a digital recording method.

The method can comprise an optical recording method.

According to another aspect of the present invention, there is provided a recording method for multilevel digital recording including the step of recording a multiple variety of optical devices within a recording medium wherein each of the multiple variety of optical structures exhibits a differing optical characteristic.

In this aspect, the said optical devices comprise at least one of holographic and/or diffractive structures.

According to yet another aspect of the present invention, there is provided an optical recording method including a step of holographically recording a visual representation of part of a signal within a recording medium.

Presently, such a further method includes the step of creating an image of the said part of the signal.

In this manner, the invention can then include repeating the display and recording steps for a sequence of adjacent parts of the said signal.

According to still another aspect of the present invention, there is provided an optical playback method for retrieving a recording produced by way of a method outlined above, including the step of directing a light beam to a recording medium comprising an optical device; moving the optical device relative to the light beam so as to introduce regions of the optical device with differing optical characteristics to the light beam; and detecting changes in characteristic of light retrieved from the different regions of optical structure during the said relative movement.

As will be appreciated, the method can including the step of retrieving the recorded signal from the said detected changes.

Also, the playback method can comprise an audio signal playback method.

Further, the playback method can detect changes in the characteristic of the light as analog or digital changes.

Of course, the invention can also provide for an optical recording head including means for producing a first modulated light beam, a second light beam, and arranged to allow for interference between the beams and for optical recording according to a method as defined above.

Likewise, the invention can also provide for an optical playback head including means for producing a light beam or impinging on the recording medium and arranged to operate in accordance with a method as defined above.

Yet another aspect of the present invention can comprise a data carrier having data recorded thereon according to the method such as that defined above.

Thus, the preservation can provide for a data carrier arranged for use with a light beam and including an optical device arrangement having different regions including different optical characteristics.

Preferably, the data carrier can have regions that are continuous and contiguous, and also wherein the optical device can comprise a continually varying holographic or diffractive structure.

As already will be appreciated a particular aspect of the invention relates to the change of characteristics of a modulated light beam in time and leads to a spatial or position change of characteristics of diffractive structure created by the interference of the light beam with other beams. The structure originated as described above is then recorded and this forms a record of the information (data storage). Movement of the (light) beam over the recorded structure causes a change of a position, direction, intensity or other characteristics of the diffracted or reflected beam, and this can be further detected in time

The invention relates to data or any physically defined information storage. The data/information can be of analogue or advanced binary data nature, preferably of base-N system alphabets, where N>2 (e.g. hexadecimal alphabet). The recording of analogue and/or discrete signals, their storage, as well as further play-back, is all encompassed within the scope of the present invention.

Methods embodying the invention can provide data storage at very dense data/information capacity while maintaining a very high quality of the information nearly incomparable with standard digital data storage techniques. Unauthorized copying and/or undesired multiplication will be markedly more difficult in comparison to the current art and related standard ways of copying and production of carrier media.

The principal aspect outlined above is as follows. A signal or data structure is encoded into a specific diffractive structure. For example, the well known two (or multiple) beam interference experiment can be used for recording of such data, where at least one arm of the beam is modulated in a way linked to the input signal. The signals can be also recorded via any known technique of Holographic Data Storage (HDS), see (Curtis book) or any method being able to produce and record the interference pattern. As an advanced way of recording, any of physical properties of light such as polarization, wavelength, quantum states, modes can be exploited to assist with recording desired information.

As will therefore be appreciated the invention relates to systems in which the signal can be recorded in the form of specific diffractive structures, preferably diffractive gratings, holograms and so on. Similarly, the reading, or data retrieval, exploits the spatial distribution of diffracted light. Thus, the diffracted light direction and/or its intensity can serve to represent the desired information. This can advantageously be used for the recording/reading of analogue audio or video signal, but has no limitations for the data or any form of information recording of the discrete (binary or even multilevel alphabet, such as hexadecimal one and so on) signals. The invention can be further extended for a variety of combination of analogue and discrete signals.

The invention is described further hereinafter, by way of example only, with reference to the accompanying drawings in which:

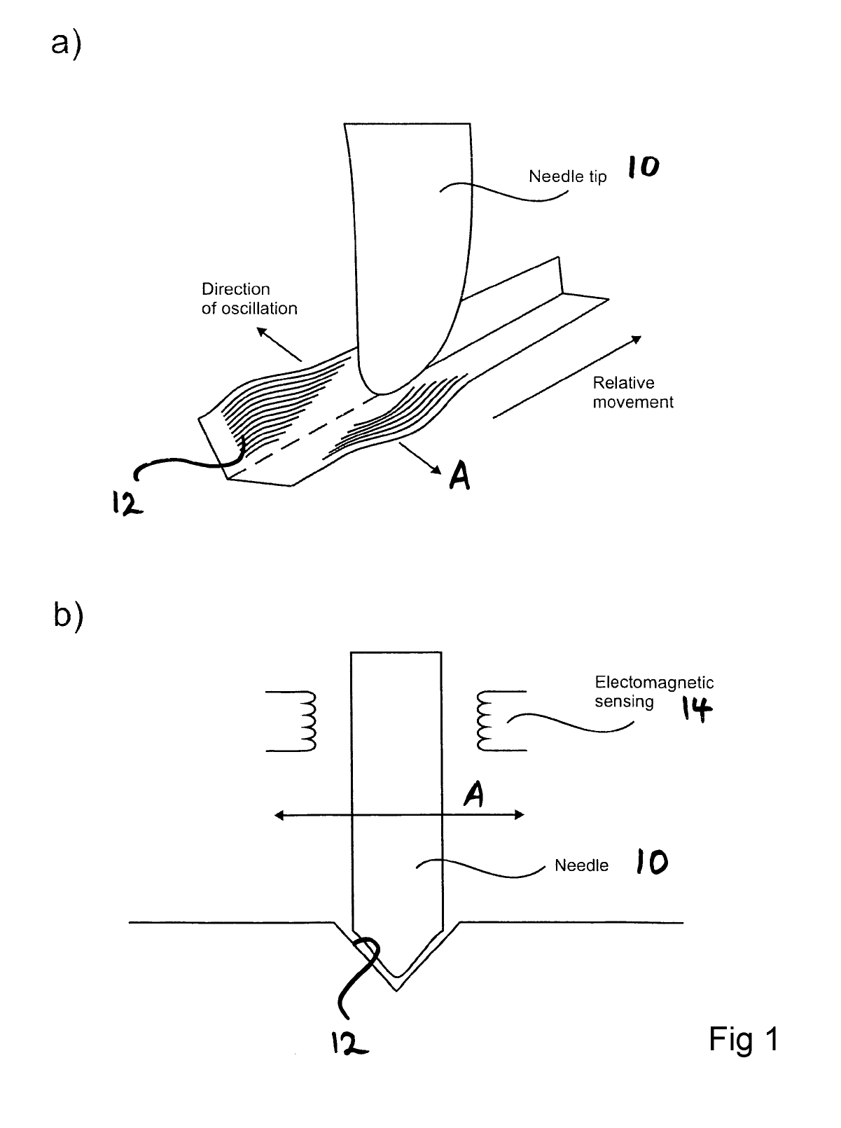

FIGS. 1a and b illustrate well-known gramophone technology;

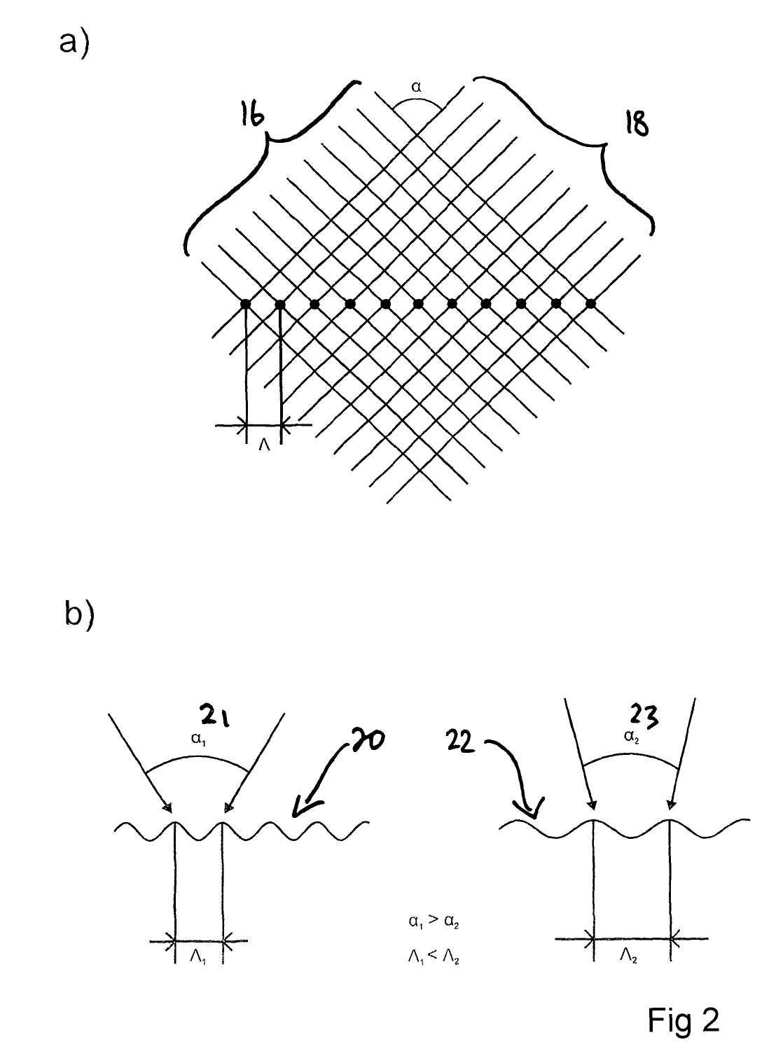

FIGS. 2a and b illustrate the principles behind interference patterns and related diffractive structures;

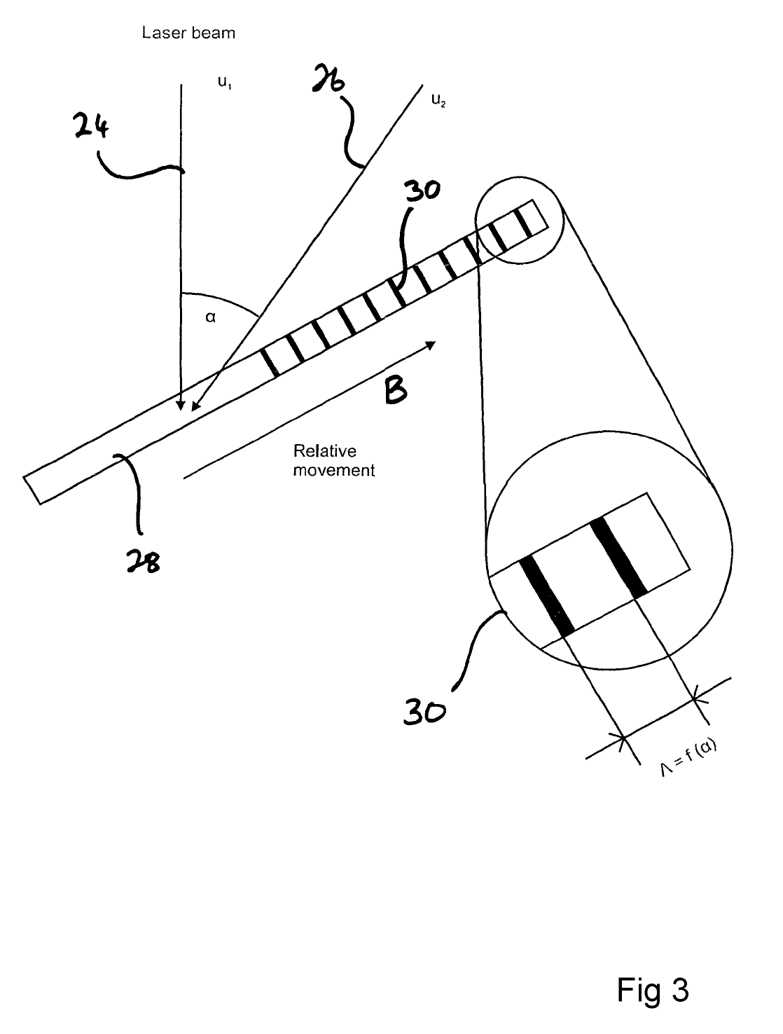

FIG. 3 is a schematic illustration of a data-recording procedure embodying the present invention;

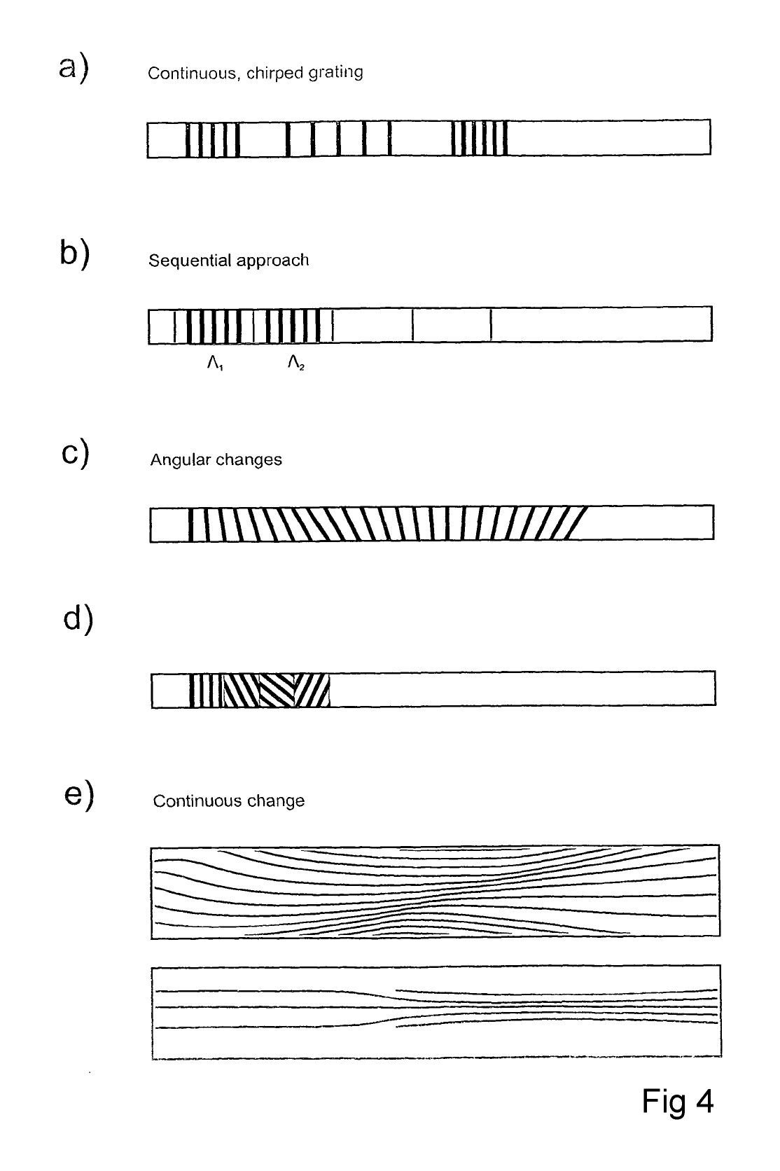

FIGS. 4a-e illustrate various differing forms of grating structure/patterns according to embodiments of the present invention;

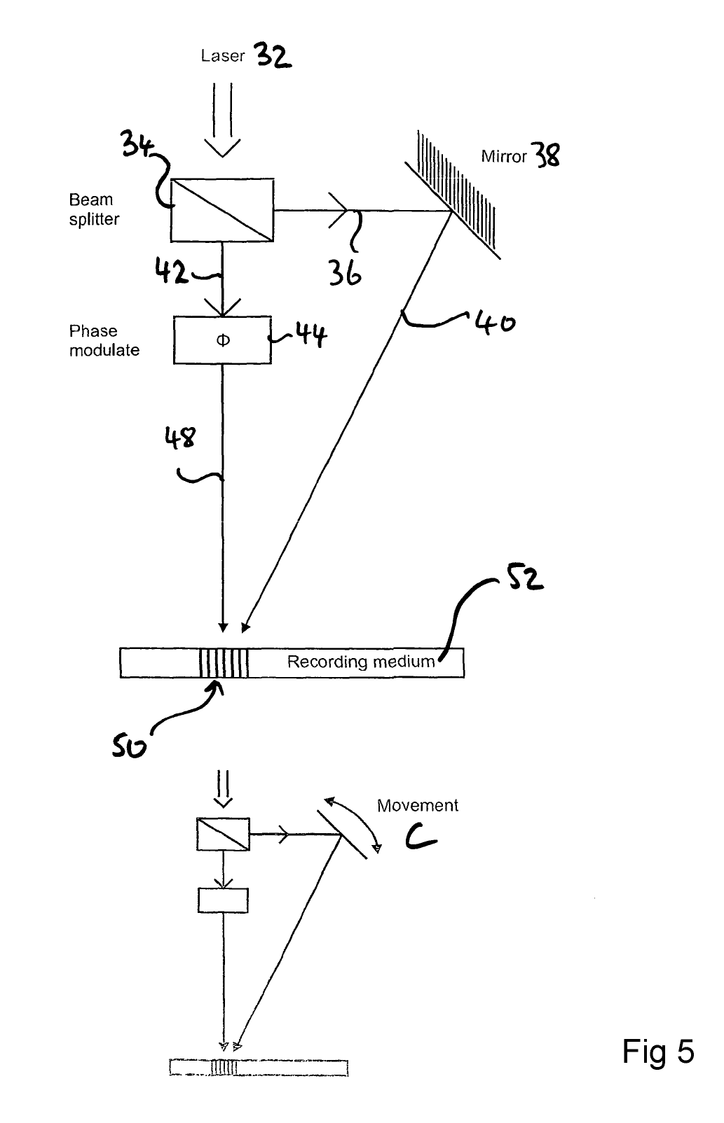

FIG. 5 is a further schematic illustration of a data-recording structure embodying the present invention;

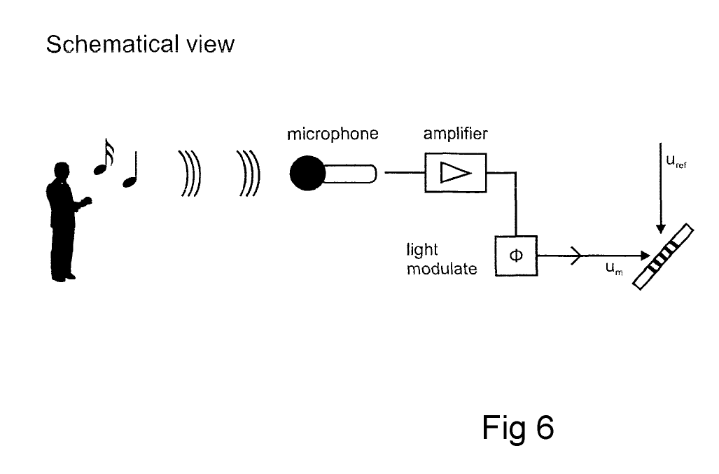

FIG. 6 is a schematic illustration of a sound recording process employing an embodiment of the present invention;

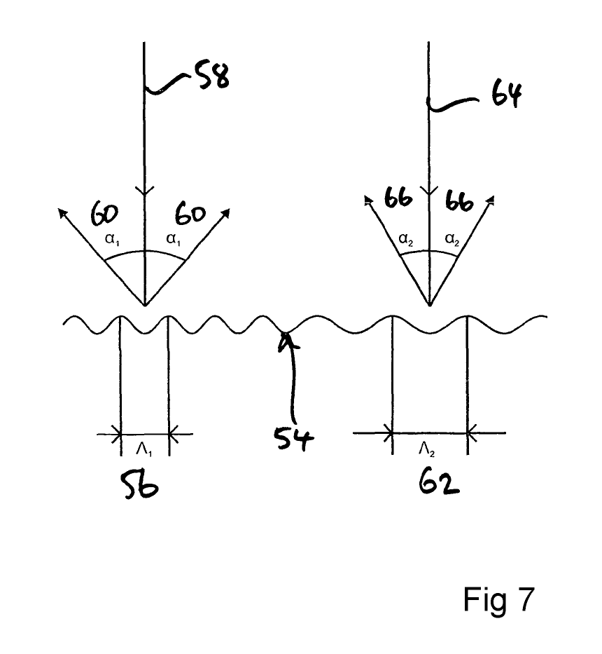

FIG. 7 serves to illustrate the relationship between grating period and angle of diffraction;

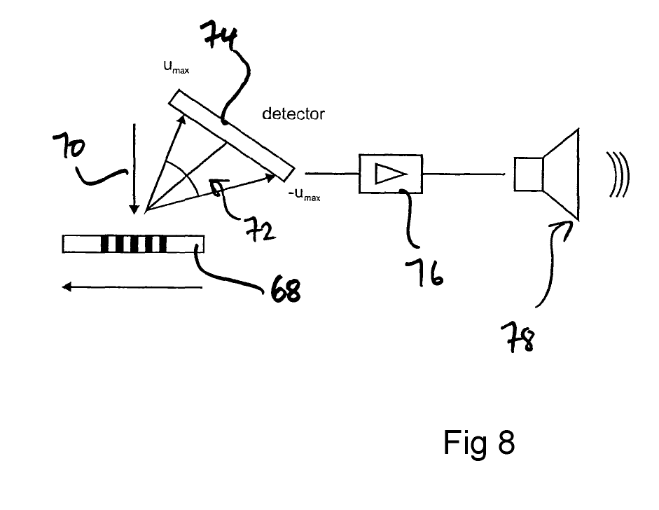

FIG. 8 is a schematic illustration of a playback arrangement according to an embodiment of the present invention;

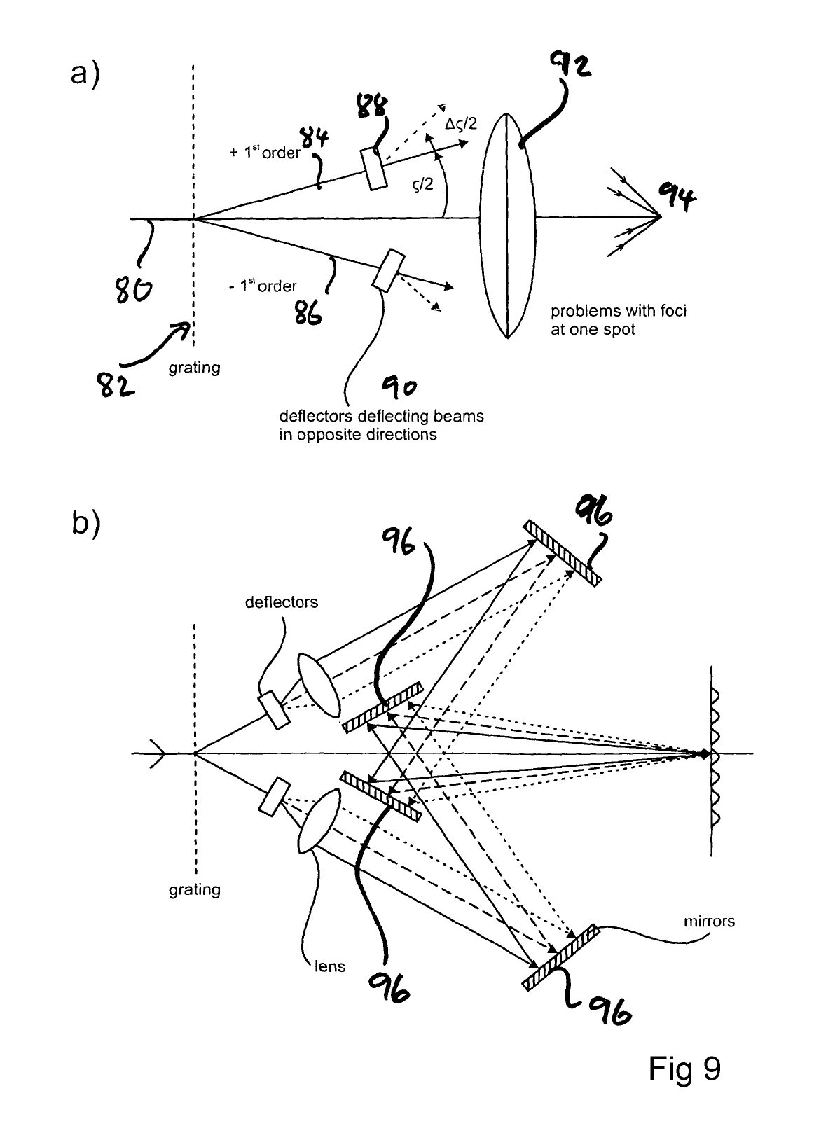

FIGS. 9a and b are schematic sensations of further details of playback arrangements according to embodiments of the present invention;

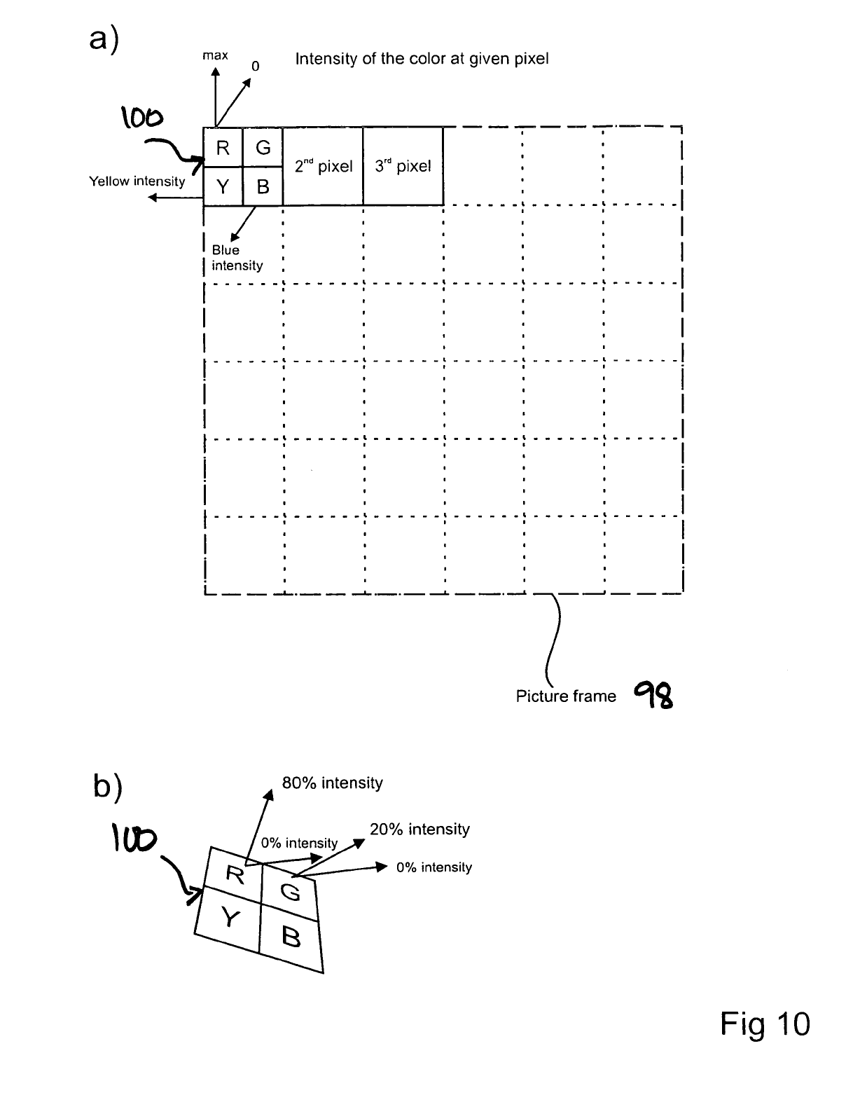

FIGS. 10a and b illustrate a multi-pixel picture frame structure employed within an embodiment of the present invention;

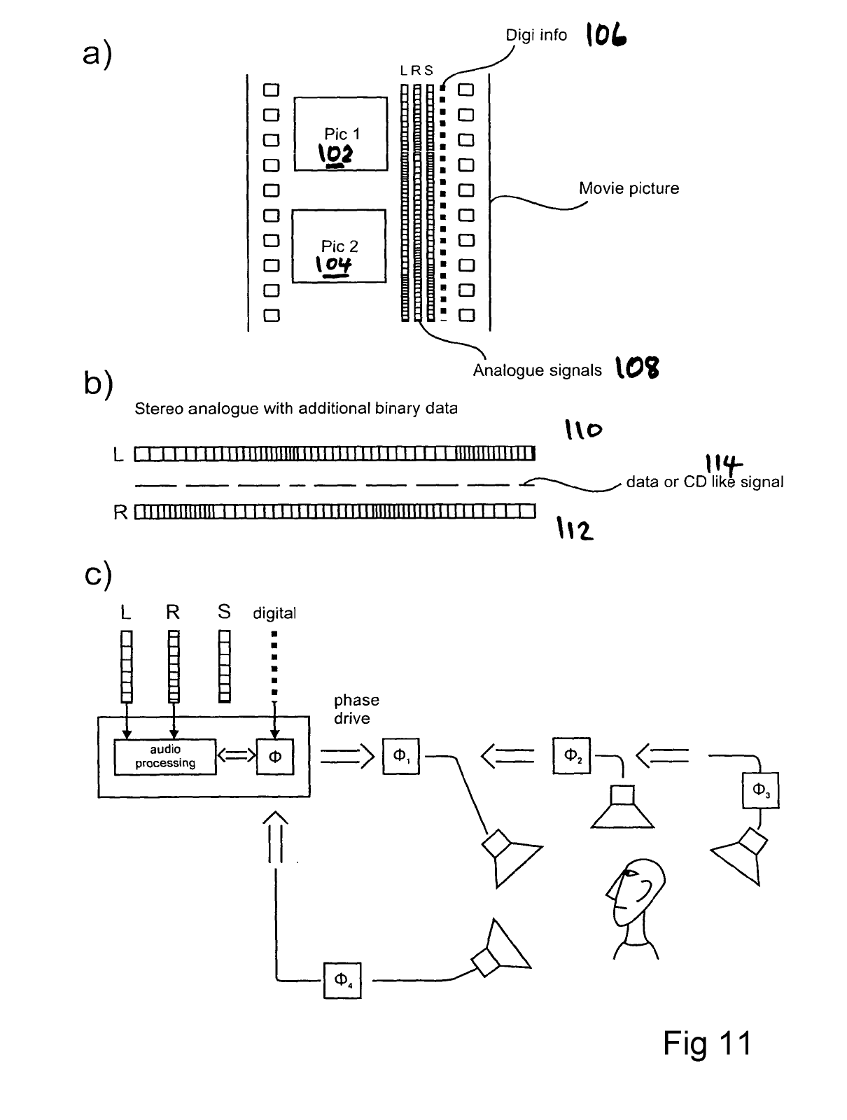

FIGS. 11a, b and c are straight aspects of the present invention within a multi-media arrangement;

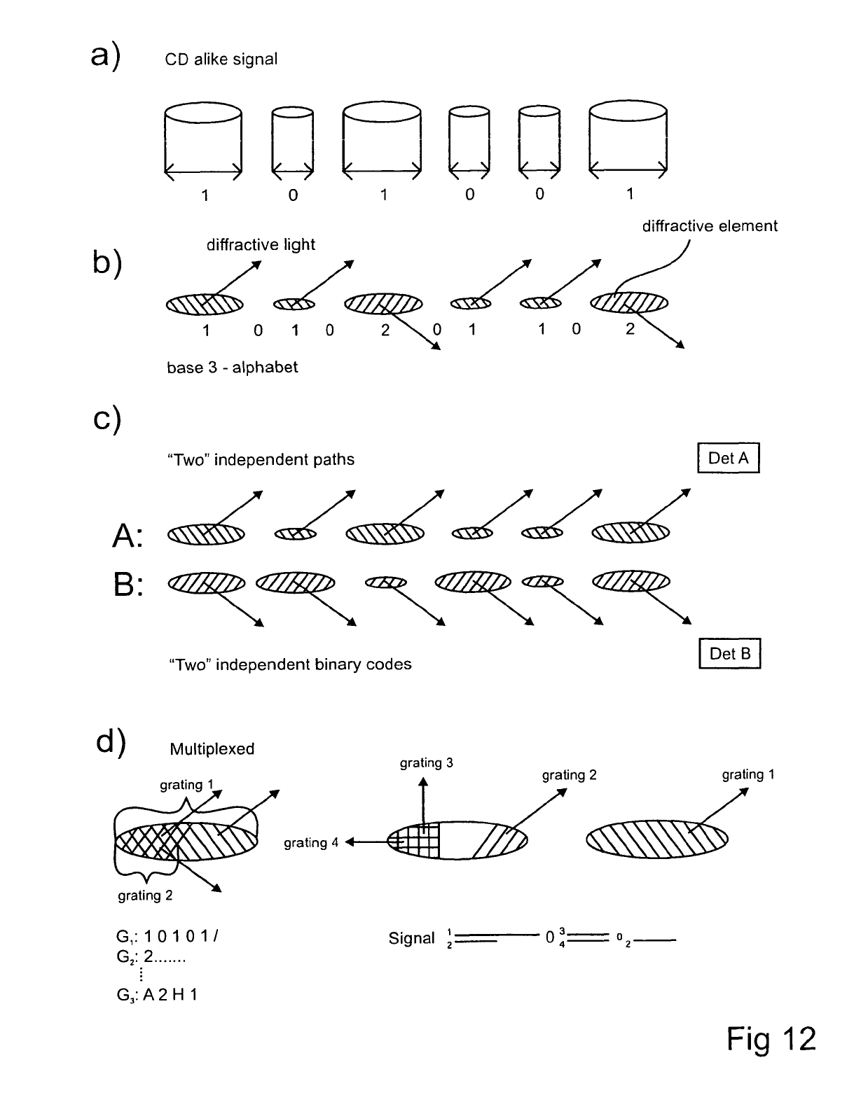

FIGS. 12a-d illustrate different examples of grating structures/configurations according to embodiments of the present invention;

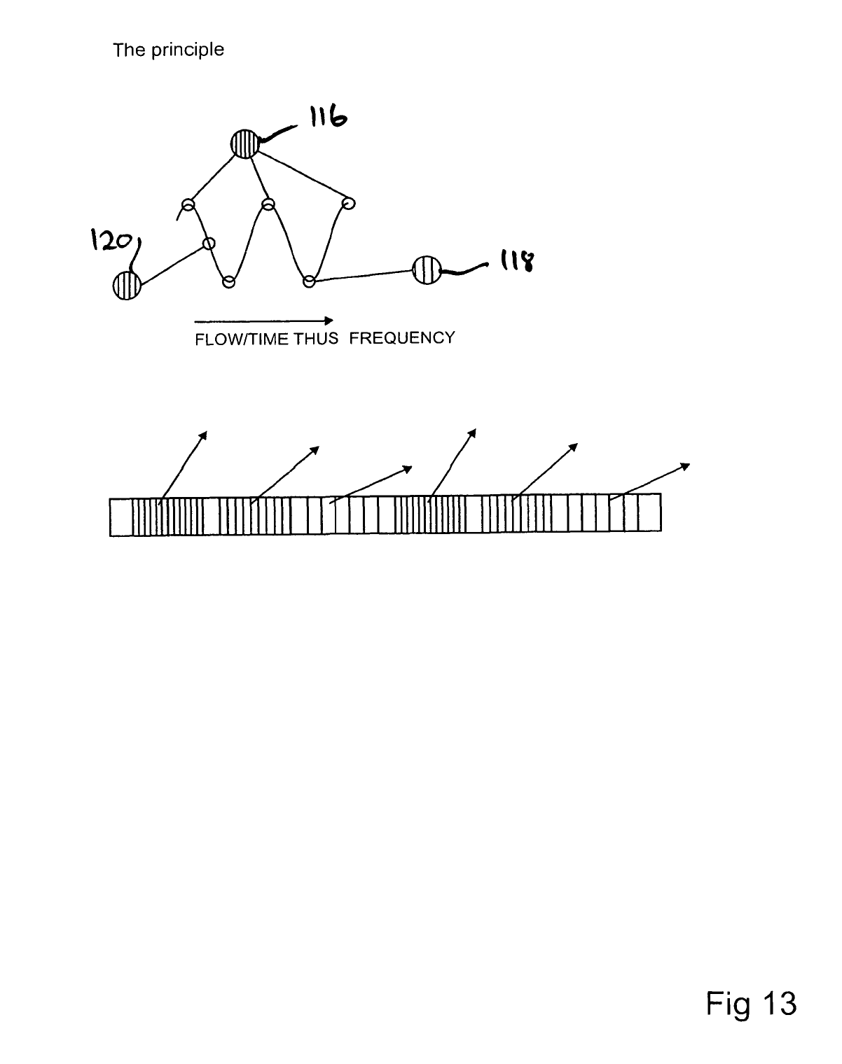

FIG. 13 is a further illustration of data-recordal representation employing an embodiment of the present invention;

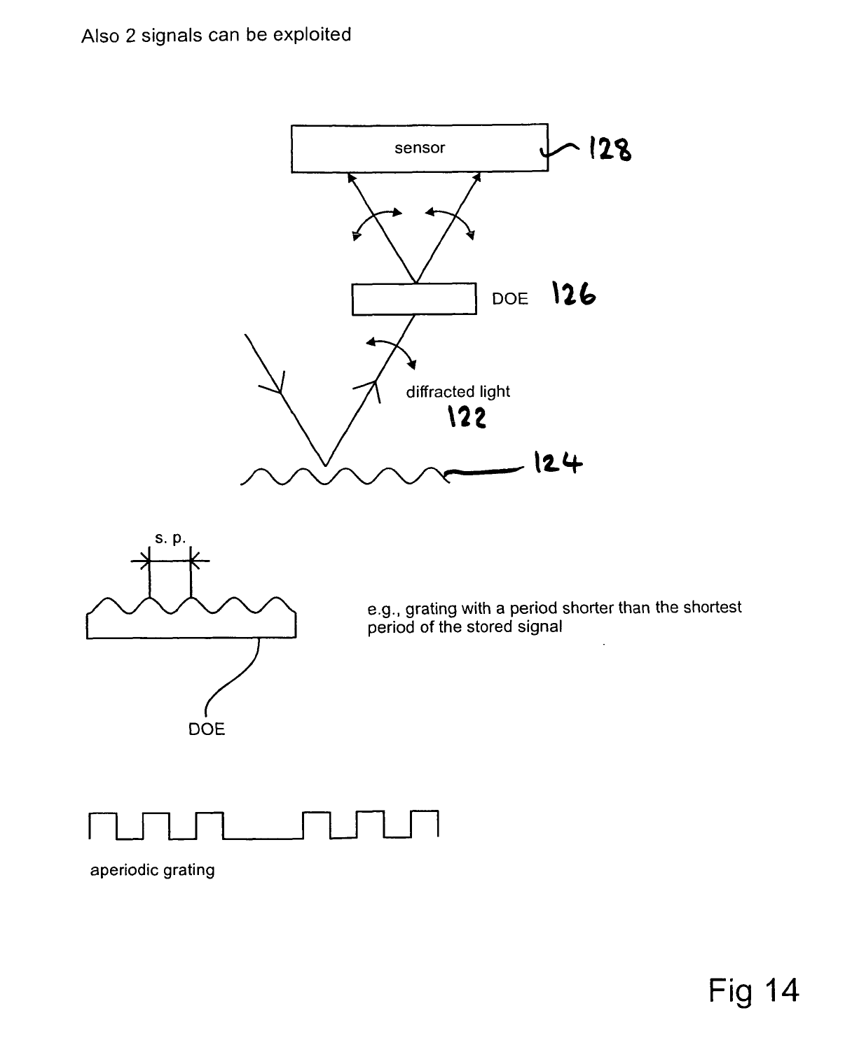

FIG. 14 the systematic presentation of bi-signal playback according to an embodiment of the present invention;

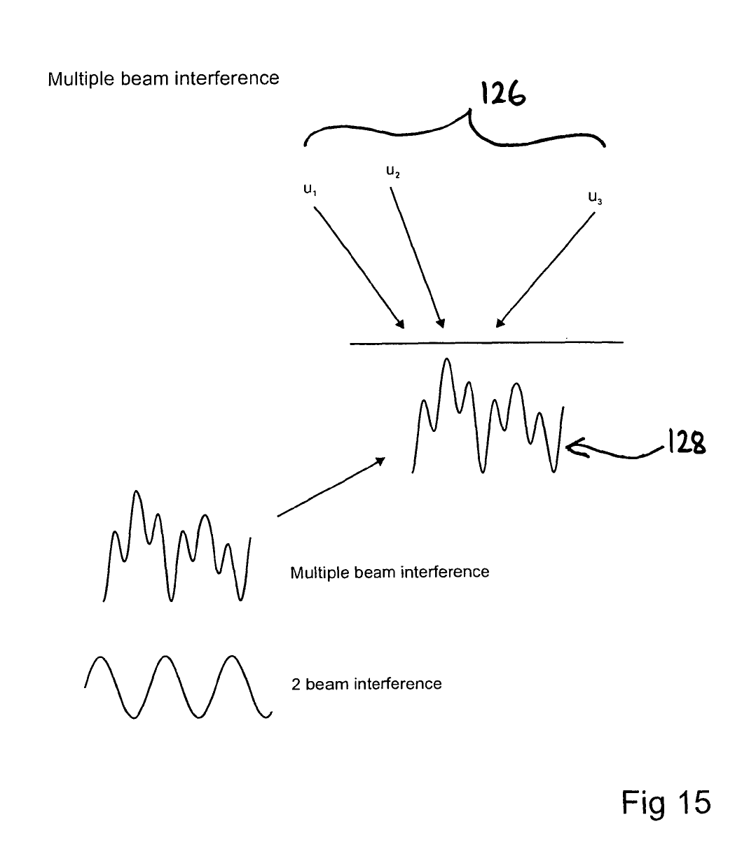

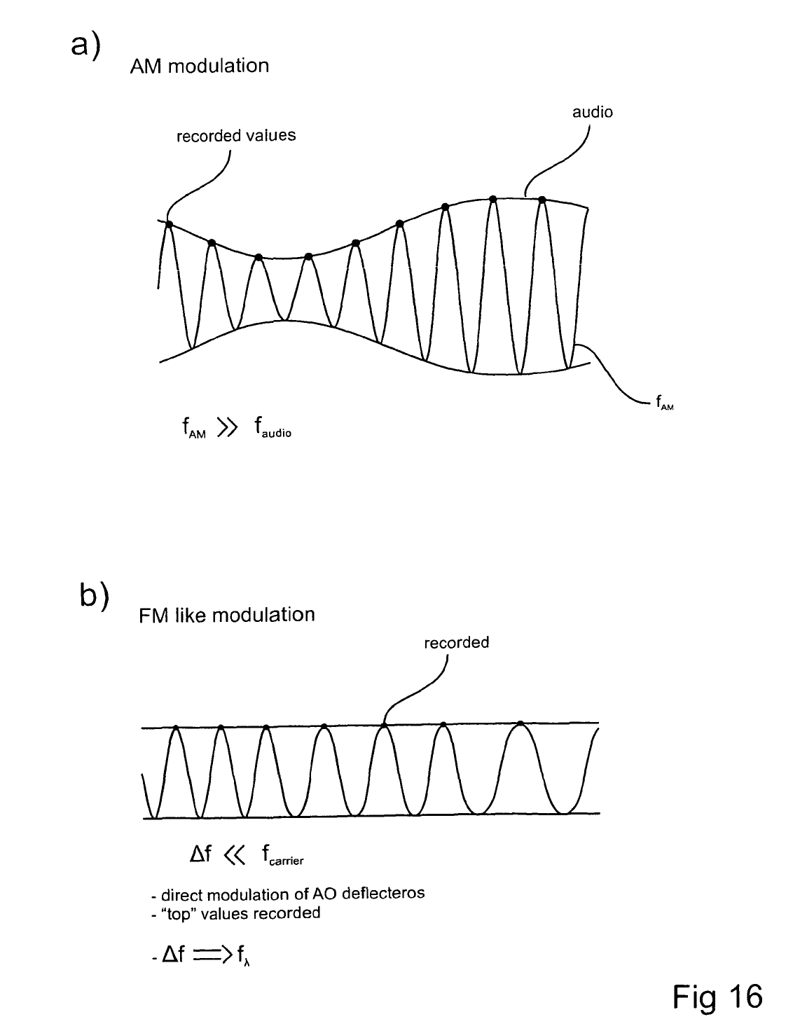

FIGS. 15 and 16 comprise further representations of interference and modulation according to the invention; and

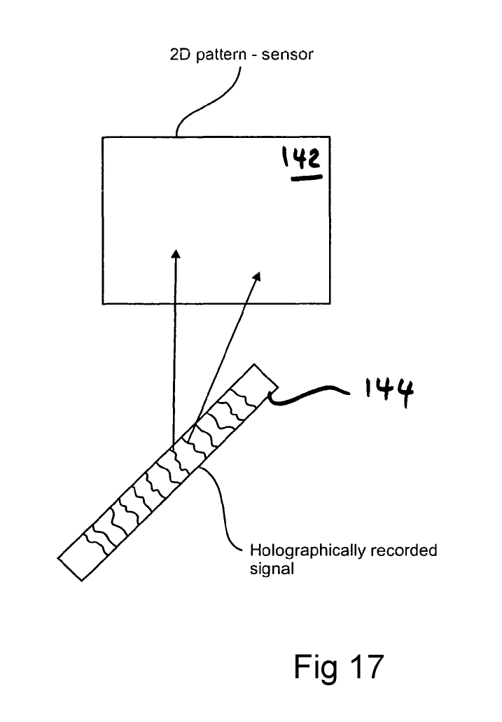

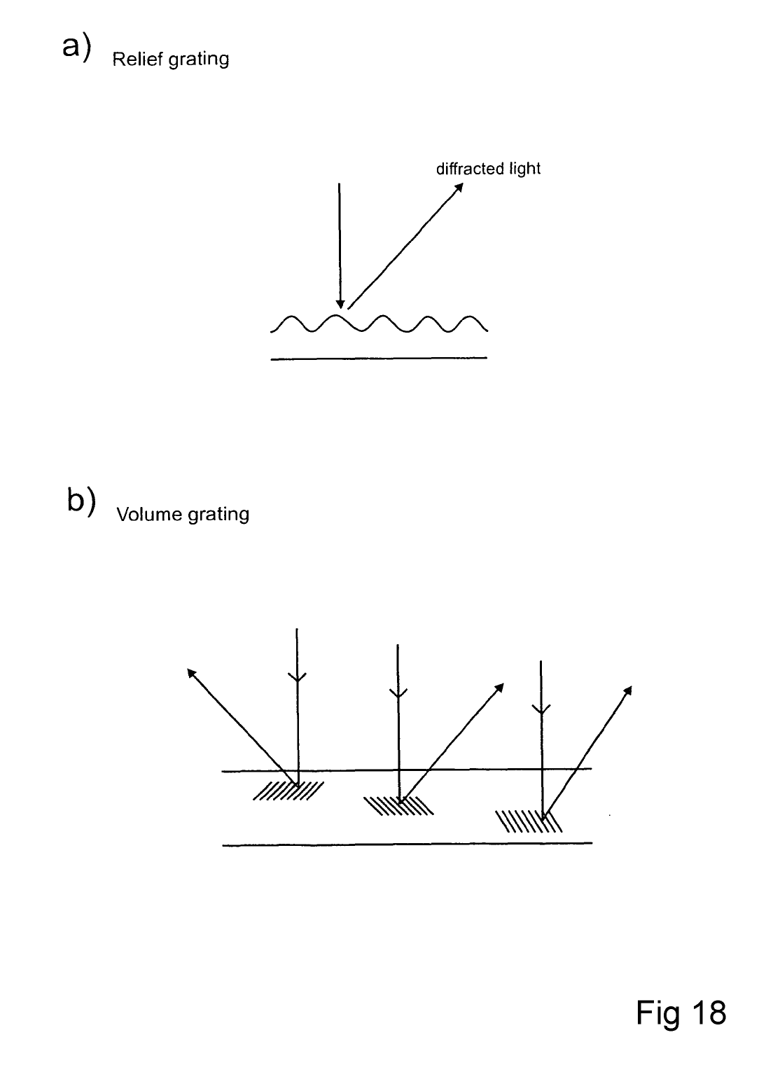

FIGS. 17 and 18 provide further illustrations of multiple, and 2-D recording, according to embodiments of the present invention.

Turning first to FIGS. 1a and 1b there is illustrated in schematic form the operational aspects of a classical gramophone, wherein a needle 10 follows a spatially modulated groove 12, while moving with a given speed. Vibrations of the needle 10 in the direction of arrow A induce the electrical signal, which is further processed by way of electromagnetic sensor 14.

A detailed description of the concept behind an embodiment of the invention employing well-known diffraction phenomena is shown in FIGS. 2a and 2b. When two (or in general more than two) coherent beams 16, 18 interfere, their mutual angle α defines the period Λ of the grating, see in particular FIG. 2b and the relationship between the mutual angles 21, 23 and the respective periods of gratings 20, 22. As a special case a collinear holography can be considered. This can be exploited for the static angle case as disclosed by Mikaelyan for the discrete diffraction, but CD/DVD like, recording. The present invention can offer the following improvement in that the angular dependence of two beam interference can be considered where the angle dynamically changes with respect to the input information.

FIG. 3 illustrates this further and is analogous to the conventional recording of a gramophone record—and at least where one of the interfering beams 24, 26 is functionally linked to the signal, while the recording media 28 is moving in the direction of arrow B relative to the spot of the interference pattern so as to form a grating structure 30. The recording media can for example comprise a linear tape, rotating disc, any meander-like of scanned structure etc. The sequence of the recording paths should advantageously be known in the time of the reading. The resulting grating grooves are then closely related to the signal, hence the period of the diffractive structure is, for example a function of the angle between the beams.

FIG. 4 illustrate various examples of different diffraction groove shapes and configurations. Example e) is a full diffraction analogy for the conventional needle gramophone. Case a) schematically depicts the grooves of continuously recorded grooves, thus storing the respective information. Further, case b) shows a discrete approach, where each cell/pixel comprises a monothematic information. Another way of recording could exploit diffractive structure with constant period, but changing the slope of the grooves (discrete case is given on d)). A continuously written grooves along the way of the media direction shows a full diffractive analogy to the classical mechanical gramophone recording, where a change of the diffractive structure instantly reflects the change of the input signal. More importantly, a combination of, for example, a) and c) cases (both being routinely written by current technical knowledge), allows for recording a two dimensional signal, that dramatically increases the capacity of the disclosed approach and leads toward storing even video and/or multichannel signals. Moreover, the parameters of the grating such as pitch or groove-depth, or in the case of volume holograms modulation can be used to save the signal information.

A particular example of a recording apparatus and procedure is schematically depicted in FIG. 5, where a laser light source 32 delivers light to a beam splitter 34 to provide for two beams. One 36 of the beams is directed to a mirror 38 to form a reference beam 40, whereas the second 42 of the beams is directed to a phase modulator 44 to become a modulated beam 48. As discussed, the beams are combined to form an interference pattern for forming a grating structure 50 on a moving recording medium 52. Thus, one beam is considered the reference beam and the other is phase/amplitude/spatially modulated. As noted, there is relative movement between the interfering beams and the recording medium 52, and this can further define the data stream or rather the frequency of the analogue signal.

More simplified schematics for the case of the sound recording are shown in FIG. 6. Sound waves undergo analog processing and sent to a light modulator. Any generalization for storing and playing-back digital signals (with known data processing and decoding) is also routinely possible.

Examples of the reading/recording relate to changes in diffraction/holographic properties and are linked to the change of the signal. This can comprise:
Continuous data, analog signals or any physically defined information: sound, video, picture signal—discrete and movie pictures
Full discrete data+few levels of data (more than binary)
Approximation of the analog signals (as noted in FIG. 4 b)

As should be appreciated, 1D-2D signals can be recorded, and volume holographic multiplexing advantageously used. For 1D signals can be in the form of data streams and analogue sound.

Turning now to FIG. 7, there is provided an illustration of the manner in which stored data/information can be retrieved, and thus played-back from a diffractive structure 54 having a portion exhibiting a first period 56. For the sake of brevity, discussion is included of only the effect of a change in period of the diffractive structure. Light 58 impinging on the diffractive structure 54 at a given place yields a spatial distribution of the diffracted light illustrated by angle 60. However, considering a portion of the structure 54 having any greater period 62, the incident light 64 changes the diffraction angle 66 as illustrated (see ref. Born-Wolf). The spatial distribution is un-ambiguously determined by laws of physical optics/diffraction. When light is detected the spatial information can be used to reveal information contained in the input signal as stored. A continuous change of the diffractive elements allows for a ready way of recording, storing, multiplicating and playing-back the information.

In so far as the information is recorded as diffractive elements the copying and multiplication of the data/information proves prohibitively complex. The median could be similar to the standard CD when provided in the form of relief holograms/DOE; or light assisted copied in the case of volume holograms.

Another important embodiment of the method is the fact that although copying and mass reproduction of such elements can be industrially performed, it would be nearly impossible to copy the data carries by means of standard tools such as equivalent to a CD burner. This leads to a near absolute protection for unwanted and undesired copying of the data stored.

FIG. 8 discloses one particular aspect of the present invention. While the recorder medium 68 moves relative to an impinging beam 70, the beam 70 is diffracted accordingly to the diffraction grating, or any related structure written in the medium 68. The light is diffracted/deflected under a given angle 72 and this angle 72 is detected by a sensor 74. The sensor 74 outputs a signal for further processing at 76 and subsequent audio output 78. This is a full analogy to a conventional gramophone, where the diffracted light beam oscillates in the same way as the gramophone needle would vibrate. The signal is then electrically processed in the known matter.

In general, the present invention represents an improvement over any digital signal recording procedure having regard to signal-accuracy. A simple inspection shows that the dynamics of the analogue signal can reach about 100 dB level. This should be emphasised that the method disclosed offers analogue signal storage with the same quality of the known approached of the digital methods. However the continuous signal is principally exceeding possibilities of, for example digital CD sound systems, as the signal reconstruction is any additional sampling free. More importantly, the presented invention offers essentially better signal/noise as well as interchannel crosstalk ratio.

This can also be used in medicinal applications or so, where the signal is recorded in the original form, without any digital processing, hence most probably perturbation. If the signal, like heart-beat echo (EKG or EEG for brain activities) is recorded with dynamics close to 100 dB, the signal can be post-processed with very high accuracy, offering a yield of desired information and so on.

With regard to the recording and reading devices—in theory, any of the previously mentioned approaches can be used. A preferred recording head structure/function is illustrated with reference to FIG. 9a, where the laser beam 80 is split through a high accuracy grating 82, to form +/− (first) diffractive order 84, 86 which is modulated via a respective acousto-optic deflector 88, 90 prior to being focused by lens 92 into a spot 94, where the interference pattern occurs and is recorded. Chromatic aberration is achieved with the help of the mirror assisted arrangement such as illustrated in FIG. 9b and employing additional mirror arrangements 96.

Another example of a recording device can be achieved via a direct modulation of the laser, that can yield laser wavelength changes proportional to the signal at the input, thus to be stored. Further techniques could be used, like the so called array waveguide grating approach (AWG) or any of antennae phased array arrangements yielding the interference spot being at one place.

A possibility of a 2D detection signal opens a broad area for usage for movie pictures storage, most likely in high quality (100 dB dynamics). FIG. 10a schematically depicts an alternative way of pixelated frame 98, where each pixel 100 bears the information encoded through the invented approach. Thus each picture frame is divided into a plurality of pixels. Each pixel comprises particular information regarding any video properties. The information is coded through a specific grating, e.g. light intensity of red, green, yellow and blue colour at every particular pixel. The intensity is given as the level between minimal and maximum diffraction angle for a beam. A variety of other information may be coded into the sub-pixel fields, like contrast, brightness, sound, data and so on. The specific pixel 100 is showing in greater detail with exemplified relative intensity values in FIG. 10b.

FIG. 11 shows a possibility of recording analogue and digital signals mutually on one media. FIG. 11 a) depicts an example of the movie-picture tape, where separate pictures 102, 104 (either in analogue, digital of presented form) are present. The video part is followed by Diffraction Assisted Data Storage (DADS) 108 based sound information, further followed by digital data information 106. In FIG. 11 b) DADS technology recorded left (L) 110 and right (R) 112 stereo signal, accompanied with a data channel 114 located there-between as illustrated. This could be somehow adjacent, the position is not crucial. An extension on a multichannel approach and/or combination with the video information or some digital data is apparent. Finally, FIG. 11c) illustrates the schematics of advanced exploitation of the DADS system, when DADS sound is recorded (e.g. left, right, surround channels), accompanied with a specific data instructions, what is further post-processed as e.g. time or phase delay to offer a specific spatial sound distribution etc.

Another important application of the method described is the introduction of more flexibility into discrete (binary) data recording. Actually, one can record either more dense data information on a specific area/volume or, more importantly, the data can be written in a form of multilevel or in more than binary system, such as the hexadecimal system and so on. With the above-mentioned possible dynamics of the system, only the resolution of the detector will the limiting factor and the data storage using this technique could lead to in general N-base digital alphabets, where N can be quite a high number. The use of the hexadecimal alphabet would require four times less space for recording the same information comparing standard binary approach. Further, the multilevel binary approach may offer a substantially increased density of the data. Taking into account that very advanced techniques of the auto data corrections are widely used, this approach offers a dramatic improvement of the digital data storage.

Turning now to FIG. 12 there is shown in FIG. 12a) standard CD like (DVD, BD) data storage, where spots bear binary type information, 0 and 1. FIG. 12b) extends the Mikaelyan approach and offers multidirectional/multidimensional data storage, where each data spot has a spatial property but may also determine the direction of the light where is to be detected. In FIG. 12c) there is considered two or more independent monothematic data-paths that can exploit, say, multiplexed spots, where each spot bears several different diffractive structure. Simple decoding of the discrete signal is shown in FIG. 12d). Thus, more binary scale languages can be inscribed into digital like code. For example the first element comprises two gratings, G1 and G2, where G1 is twice as long as G2. The second element comprises G4, G3, and G2, and the third element comprises only G1. Each grating radiates the diffraction pattern into a particular position where a detector is located. One can read the only signal for respective gratings and can read all the signals from many gratings and a decoded signal is schematically illustrated in FIG. 12.

Laser wavelength multiplexing and/or volume multilevel recording can be advantageously used for this approach. Such techniques have been studied extensively and more details are found in the Psaltis and Curtis references noted above. The hologram/diffractive structure can be recorded in a form of a surface gratin or, volume grating etc. Any known materials and approaches can be used for this technique with no principal limitations.

Next, FIG. 13 shows a possible way of storing a particular signal in a form of sine wave. As can be seen, the maximum amplitude relates to the shortest period grating 116, and the minimal amplitude relates to the longest period grating on 18. Accordingly the “zero” amplitude would relate to a grating with an approximately average period 120. The sine-like signal can be coded through the pertinent diffractive structures as indicated. The lower part of FIG. 13 also schematically indicates the angle of the diffracted beam further illuminating the detector. The movement of the diffractive structure relates to the dynamic changes of the signal and so serves to define the frequency of the signal at a detected point.

If for some applications, the signal from the diffrative structure might be considered rather weak, and comprising a broad spectrum of spatial frequencies, and that the principal maximum of the diffraction order will be rather broad, an extra Diffractive Optical Element (DOE) such as a grating of preferably shorter period than the shortest period of the diffractive signal structure, can be included into the optical path. This can cause splitting of the signal into two or more identical signals, or the DOE can be of a more advanced nature such as an aperiodic grating (see Veldkamp, Appl. Opt. 1982, p. 3209), that can spatially modulate the profile of the light to enhance detection and as is illustrated in relation to FIG. 14 wherein the light to be diffracted from a grating structure 124 is incident on a diffractive optical element 126 before infringing on a sensor 128.

FIG. 15 schematically illustrates an arrangement of multiple beam 126 interference, wherein at least one beam is modulated. Similarly, detection decoding of the signal can be achieved via a similar experimental arrangement where the signal can be obtained with a help of multiple beam interference 128.

FIG. 16 illustrates an approach to the invention exploiting amplitude and/or frequency modulation wherein only certain discrete information relating to the envelope (in AM) is to be recorded. In general, some other modulation techniques can be used with no limitations. For example, an FM modulated signal can be used directly for driving an acousto-optic modulator to deflect the light as described above.

FIG. 17 illustrates yet a further possibility for recording on a sensor 142 a spatially complex shape of recorded grating grooves 144 thus offering 2D pattern on the sensor. This can increase the capacity of the system dramatically over some of the earlier examples above which are considered as “1D sensors”.

Finally, FIG. 18 shows two examples of possible ways of recording holograms and or diffractive structures (cross sections shown here)—a) is for relief gratings, while the example b) schematically illustrates volume style holograms and grating. DADS can be recorded with a help of many hologram recording techniques.

The principal technique behind a main embodiment of the invention can be summarized briefly in the following. We actually consider a basic wave optics two beam interference experiment, where two beams interfere under a given angle (see FIGS. 2 a, b). It is well known from the literature (Born-Wolf, Principles of Optics, Chap. 7, Cambridge University Press, 2001), that two (in general more than two) coherent beam interfere at the specific locations where the beams have the same phase. Actually, the intensity is zero where phases of the interacting beams are of opposite value and the intensity of the interference pattern is maximal where the beams are of the same phase. This can be seen from FIG. 2 a), where the wave-front of the plane waves are schematically depicted. The mutual angle between the two plane waves is α. The places with the same phase are depicted by black points. Thus the intensity reaches maximum value at those points. The distance between adjacent interference maxima depends on the mutual angle of the interacting beams, determined as Λ. This method is usually used to originate and record diffraction gratings. The interference pattern is recorded, for example, to a photoresist. The places with the greater intensity will cause a change of the photoresist (phase change of amplitude after proper developing as well known even from a classical photography). As an example, the relief grating is made after developing the irradiated surface with the interference pattern. The cross section of the grating is depicted on either picture at FIG. 2b). It can further be seen from FIG. 2 b), that the greater angle between the beams will cause shorter period of the grating/diffractive structure and vice versa. Period and the recording angle are linked through the relation λ/Λ=2 sin(α/2), where λ is the wavelength of the interacting coherent radiation.

The present invention can advantageously consider this method exploited in the following way. Principally, either beam (i.e. at least one, or more or all in the case of the multibeam inteference) can be modulated. Modulation means a change of some physical properties of the beam. However the most common way of modulation of the beam(s) would be a change of the angle of the beam with respect to the other beam(s) or to the substrate, where the interference pattern is to be recorded. Desired change of the angle is linked the variations of the input signal/information. So, it could be a binary/discrete change of the angle in the case of the digital data. More importantly, and considering an analogue signal such as sound, the angle between the interfering beams will fully depend on the variation of the harmonic signals. This can be seen from FIG. 13, where gratings relating to a specific position of the sinusoidal wave are schematically depicted. For example a notation is chosen such that the “high” amplitude is recorded via a grating with a shortest period, while the “low” amplitude is coded through the longest period. Obviously, any point of the sinusoidal wave in between the extreme values will be represented by gratings with the period in between the interval of the periods according to the actual position on the harmonic signal to be recorded. This can be more clearly described on the, say, “diffractive analogy of the gramophone”. We consider a carrier, where the data/signal via the disclosed invention is to be recorded. This can preferably be of a form of a thin “infinite” stripe as on FIG. 13 below or this could be a rotating disc, where the diffraction grooves are to be recorded on a spiral. The carrier/substrate relatively moves with respect to the writing head. The writing head, like that one from FIG. 9. is able to produce instantly an interference pattern relating to an actual signal (e.g. amplitude) at a given moment. There is a variety of ways how to record the grooves, shown on FIG. 4. This relates to spatial, azimuth, spatial frequency arrangement of the writing head and/or discrete or continuous information recording. The relative movement of the carried actually determines the frequency of the signal or data stream for the case of the discrete data recording. The process of the recording is also depicted on FIG. 3, where some part of the stripe (on the right) was already recorded, while the two beam are actually writing to a pertinent spot beneath. The left part of the stripe is yet to be recorded. Analogously, the reading will exploit the same approach with a relative movement of recorded information on a spiral, stripe, meander and many others mathematically defined paths. FIG. 8 shows the relatively moving carrier. An impinging beam is diffracted. Its diffraction angle is given by the actual period of the diffractive structure at the given (illuminated) point. The direction of the diffracted beam determines, e.g. the amplitude of the signal on the detector, while the frequency of the signal or the data stream is determined by the relative movement speed.

A short mathematical inspection shows, that exploiting a standard acousto-optical deflector would guarantee a dynamic range of the stored signal with 100 dB. For such value, it is necessary to distinguish five orders difference between the weakest and the strongest signals. Considering an arrangement of the writing head as depicted on FIG. 9, the beam would be deflected by 3-4 degrees each. This renders seven degrees available for the desired dynamics of the recording. These seven degrees divided by 100000 (100000 ‘parts’ relate to 100 dB) yields approximately 0.25 angular seconds. On the other hand for 1 angular second resolution of the deflectors a resolution of approx 25000 elementary signal units can be achieved and fifth relates to 88 dB. As the analogue signal can be compressed prior storage by tens of dBs, the conditions for the angular deflection of the beams will be considerably relaxed. A method embodying the invention is able to record an analogue signal with dynamics about 100 dB. Moreover, inter-channel crosstalk can be in limit close to zero (zero means no crosstalk at all), as the channels (like left and right channel) can be recorded independently as well as the signal will be retrieved by two independent light beams.

In yet further detail, it should be appreciated that the method of the interference assisted recording can originate relief micro-changes, density changes or change of the refractive index. The materials used are, for example, photoresists, polymers (polymers can use photochanges of can be ablated by the laser beam), waxes, photosensitive density-changing materials, photopolymers. Substrates can comprise materials such as glasses, polycarbonates of similar thermoplastics, metals, all variants as nominated above, but comprising a conductive layer(s). Anti-reflex and/or anti-scratch coatings can be provided on the top of the disk/tape/media.

Industrial multiplication of the master copy can be achieved through a (micro)relief embossing, either at different refractive indices interface or at a metallic interface. Further, the multiplication can be done via contact-less or rather optical copying, such as relief or density of refractive index changes. A relief-type microstructure can be further multiplied by conventional techniques like CD, DVD etc, embossing/casting, or the optical reproduction. Density-media changes can be multiplied via optical copying of two different media/carrier densities, analogously at the density/refractive indices changes. Also optical-mechanical multiplication, i.e. transforming density/relief by optical means and further mechanical copying can be provided. Further, they carrier with refractive index changes can be copied optically (two different indices), multiplied optically (refractive index change with density variation) or copied from a photopolymer to a relief structure.

The record of the signal/data can be located on the surface, embedded within or covered by a protecting layer—but all presented as a single layer. However, multi-layer and multi-layer with continuous changes, recording methods can readily be employed. The tracking paths for the beam can be arranged in the plane of the record, or above or below as appropriate.

1. A recording method comprising the steps of modulating a first light beam for recording purposes; directing a second light beam to interfere with the said first light beam to produce an interference pattern in the region of a recording medium; forming an optical device in the said medium responsive to the said interference pattern and wherein optical characteristics of the said optical device are varied responsive to variations in the said interference pattern.

2. A method as claimed in claim 1, wherein the first and second light beams comprise coherent light.

3. A method as claimed in claim 2, wherein the first and second light beams comprise laser light beams.

4. A method as claimed in claim 1, wherein said first beam is modulated by a light modulator.

5. A method as claimed in claim 4, wherein the light modulator comprises an acoustic-optic deflector or electro-optic or mechanical-optical or nonlinear optical modulator.

6. Our method as claimed in claim 1, wherein the modulation is applied to a driving source of at least the said first light beam to produce a modulated output.

7. A method as claimed in claim 1, and including splitting the said first light beam prior to the said modulation step.

8. A method as claimed in claim 1, and including splitting the beam after modulation.

9. A method as claimed in claim 8, wherein at least two parts of the split beam are modulated.

10. A method as claimed in claim 9, wherein the said at least two parts of the split beam are recombined for recording purposes.

11. A method as claimed in claim 1, wherein the said second beam comprises a reference beam.

12. A method as claimed in claim 1, wherein said first and second beams are focused onto/into the recording medium

13. A method as claimed in claim 1, and including the step of moving the recording medium relative to the said interference pattern.

14. A method claimed in claim 1, wherein the recording medium is in the form of at least one of a disk or tape, surface, one-level, multilevel or volume recording medium.

15. A method as claimed in claim 1, wherein the recording medium comprises a material exhibiting at least one of density, refractive index or micro-relief changes.

16. A method as claimed in claim 1, wherein said optical device comprises at least one of a holographic and/or diffractive structure.

17. A method as claimed in claim 16, wherein the optical device comprises a diffractive grating structure.

18. A method as claimed in claim 17, wherein the said optical characteristic of the said structure comprises at least one of period, pitch, profile shape and/or high or modulation and orientation of the grating structure.

19. A method as claimed in claim 16, and including the step of causing the said optical characteristic to vary in at least one of a substantially continuous, stepwise and/or discrete manner in the direction of relative movement between the interference and/or holographic pattern and the recording medium.

20. A method as claimed in claim 19, and forming the optical characteristic as a track in the recording medium.

21. A method as claimed in claim 19, and forming discrete optical devices aligned in the direction of relative movement between the interference pattern and the recording medium or otherwise spatial relation.

22. A method as claimed in claim 21, and forming the discrete optical devices in discrete regions of the recording medium.

23. A method as claimed in claim 22, and including forming a plurality of differing optical devices within a common discrete region or arranged in a continuous region.

24. A method as claimed in claim 1 and comprising an analogue recording method.

25. A method as claimed in claim 1, and comprising a digital recording method.

26. A method as claimed in claim 1, wherein the optical characteristic of the device is representative of a point on an analogue signal.

27. A method as claimed in claim 1 and comprising an optical recording method.

28. A method as claimed in claim 1 and employing multi-beam recording having at least one modulated beam.

29. A recording method for multilevel digital recording including the step of recording a multiple variety of optical devices within a recording medium wherein each of the multiple variety of optical structures exhibits a differing optical characteristic.

30. A method as claimed in claim 29, wherein said optical devices comprise at least one of holographic and/or diffractive structures.

31. A method claimed in claim 29, wherein the said optical characteristic comprises at least one of period, pitch or angle profile shape and/or high or modulation of the grating structure.

32. An optical recording method including a step of holographically recording a visual representation of part of a signal within a recording medium.

33. A method as claimed in claim 32, and including the step of creating an image of the said part of the signal.

34. A method as claimed in claim 32, and including repeating the display and recording steps for a sequence of adjacent parts of the said signal.

35. A method as claimed in claim 32, and comprising an audio signal recording method or video signal or both.

36. An optical playback method for retrieving a recording produced by way of a method of claim 1, including the step of directing a light beam to a recording medium comprising an optical device; moving the optical device relative to the light beam so as to introduce regions of the optical device with differing optical characteristics to the light beam; and detecting changes in characteristic of light retrieved from the different regions of optical structure during the said relative movement.

37. A playback method as claimed in claim 26, and including the step of retrieving the recorded signal from the said detected changes.

38. A playback method as claimed in claim 37, and including directing the said light retrieved to an opto-detector.

39. A playback method as claimed in claim 36, wherein the light beam comprises coherent light.

40. A playback method as claimed in claim 36, and comprising an audio signal playback method.

41. A playback method as claimed in claim 36, wherein the said changes in the characteristic of the light are detected as analog changes.

42. A playback method as claimed in claim 36, wherein the said changes in the characteristic of the light are detected as digital changes.

43. An optical playback method for retrieving a recording according to a method of claim 32, including irradiating a recording medium so as to recreate an image of part of a signal, and directing the said image to an opto-electric transducer for deriving a signal corresponding to the said image.

44. An optical recording head including means for producing a first modulated light beam, a second light beam, and arranged to allow for interference between the beams and for optical recording according to a method as claimed in claim 1.

45. An optical playback head including means for producing a light beam or impinging on the recording medium and arranged to operate in accordance with the method as defined in claim 36.

46-51. (canceled)
